(19) United States
(12) Patent Application Publication
(10) Pub. No.: US 2026/0073881 A1
(43) Pub. Date: Mar. 12, 2026

(54) DISPLAY DEVICE AND ELECTRONIC DEVICE INCLUDING THE SAME

(71) Applicant: Samsung Display Co., Ltd., Yongin-si (KR)

(72) Inventor: CHUL KIM, Yongin-si (KR)

(21) Appl. No.: 19/235,147

(22) Filed: Jun. 11, 2025

(30) Foreign Application Priority Data
Sep. 6, 2024 (KR) 10-2024-0121562

(51) Int. Cl. G09G 3/3291; G09G 3/32

(52) U.S. Cl. CPC G09G 3/3291; G09G 3/32; G09G 2310/0275; G09G 2310/0286; G09G 2330/023

(57) ABSTRACT

A display device includes a display panel including pixels, and configured into blocks, a data driver configured to provide a data voltage to the display panel, a power management integrated circuit including power voltage circuits implemented as one integrated circuit, packaged together, and configured to output power voltages respectively to the blocks of the display panel, and a driving controller configured to control the data driver and the power management integrated circuit based on input image data.

### CROSS-REFERENCE TO RELATED APPLICATION

The present application claims priority to, and the benefit of, Korean Patent Application No. 10-2024-0121562, filed on Sep. 6, 2024, in the Korean Intellectual Property Office, the entire disclosure of which is incorporated herein by reference.

### BACKGROUND

### 1. Field

Embodiments of the present disclosure relate to a to a display device and an electronic device including the same for precisely setting a power voltage to reduce a power consumption and to improve a display quality.

### 2. Description of the Related Art

In general, a display device includes a display panel and a display panel driver. The display panel includes gate lines, data lines, and pixels. The display panel driver includes a gate driver for providing a gate signal to the gate lines, a data driver for providing a data voltage to the data lines, and a driving controller for controlling the gate driver and the data driver. The display panel driver may further include a power management integrated circuit for generating a power voltage and outputting the power voltage to the display panel.

To reduce a power consumption of the display device, the display panel may be divided into blocks. The driving controller may determine levels of power voltages applied to each of the blocks, and the power management integrated circuit may output the power voltages to the blocks through power voltage lines. Meanwhile, unlike the prior art, because the power management integrated circuit outputs various power voltages, a problem in which a size of the power management integrated circuit increases has occurred.

### SUMMARY

Embodiments of the present disclosure provide a display device for reducing a size of a power management integrated circuit.

Embodiments of the present disclosure provide an electronic device including the display device.

In one or more embodiments of a display device according to the present disclosure, the display device includes a display panel including pixels, and configured into blocks, a data driver configured to provide a data voltage to the display panel, a power management integrated circuit including power voltage circuits implemented as one integrated circuit, packaged together, and configured to output power voltages respectively to the blocks of the display panel, and a driving controller configured to control the data driver and the power management integrated circuit based on input image data.

As a maximum grayscale of the input image data for one of the blocks increases, a corresponding one of the power voltages for the one of the blocks may increase.

The power management integrated circuit may further include multiplexers configured to respectively output the power voltages in response to a selection signal.

The power management integrated circuit including the power voltage circuits and the multiplexers may be packaged as one integrated circuit.

The driving controller may be configured to output the selection signal.

The power management integrated circuit may further include a shift register configured to generate the selection signal in response to a control signal from the driving controller.

The power management integrated circuit may further include a pulse counter configured to generate the selection signal in response to a control signal from the driving controller.

The display device may further include a power selection integrated circuit including multiplexers configured to respectively output the power voltages to the blocks in response to a selection signal.

The power management integrated circuit including the power voltage circuits may be implemented as one integrated circuit packaged as one, wherein the power selection integrated circuit including the multiplexers is implemented as one integrated circuit packaged as one.

The driving controller may be configured to output the selection signal.

The power selection integrated circuit may further include a shift register configured to generate the selection signal in response to a control signal from the driving controller.

The power selection integrated circuit may further include a pulse counter configured to generate the selection signal in response to a control signal from the driving controller.

In one or more embodiments of an electronic device according to the present disclosure, the electronic device includes a display panel including pixels, and configured into blocks, a data driver configured to provide a data voltage to the display panel, a power management integrated circuit including power voltage circuits packaged together, implemented as one integrated circuit, and configured to output power voltages respectively to the blocks of the display panel, a driving controller configured to control the data driver and the power management integrated circuit based on input image data, and a processor configured to provide the input image data and an input control signal to the driving controller.

As a maximum grayscale of the input image data for one of the blocks increases, a corresponding one of the power voltages applied to the one of the blocks may increase.

The power management integrated circuit may further include multiplexers configured to output the power voltages respectively to the blocks in response to a selection signal.

The power management integrated circuit including the power voltage circuits and the multiplexers may be implemented as one integrated circuit and is packaged as one.

The driving controller may be configured to output the selection signal.

The power management integrated circuit may further include a shift register configured to generate the selection signal in response to a control signal from the driving controller.

The power management integrated circuit may further include a pulse counter configured to generate the selection signal in response to a control signal from the driving controller.

The electronic device may further include a power selection integrated circuit including multiplexers configured to output the power voltages respectively to the blocks in response to a selection signal.

According to the display device and the electronic device, the display panel may be divided into the blocks, and the power management integrated circuit may include the power voltage circuits, which output each power voltage to each of the blocks. The power voltage circuits may be implemented as the one integrated circuit, and the power voltage circuits implemented as the one integrated circuit may be packaged together. Accordingly, the size of the power management integrated circuit may be reduced.

### BRIEF DESCRIPTION OF THE DRAWINGS

The above and other aspects of embodiments of the present disclosure will become more apparent by describing in detailed embodiments thereof with reference to the accompanying drawings, in which:

FIG. 1 is a block diagram showing a display device according to embodiments of the present disclosure;

FIG. 2 is a diagram showing a power voltage line structure of a display panel of FIG. 1;

FIG. 3 is a circuit diagram showing a pixel of FIG. 1 according to one or more embodiments;

FIG. 4 is a block diagram showing a driving controller of FIG. 1 according to one or more embodiments;

FIG. 5 is a block diagram showing blocks of a display panel and a power management integrated circuit of FIG. 1 according to one or more embodiments;

FIG. 6 is a plan view showing a display device of FIG. 1 according to one or more embodiments;

FIG. 7 is a diagram showing a power management integrated circuit having a package form according to one or more embodiments;

FIG. 8 is a diagram showing a power management integrated circuit having a package form according to one or more embodiments;

FIG. 9 is a diagram showing a power management integrated circuit having a package form according to one or more embodiments;

FIG. 10 is a diagram showing a power management integrated circuit having a package form and a power selection integrated circuit having a package form according to one or more embodiments;

FIG. 11 is a diagram showing a power management integrated circuit having a package form and a power selection integrated circuit having a package form according to one or more embodiments;

FIG. 12 is a diagram showing a power management integrated circuit having a package form and a power selection integrated circuit having a package form according to one or more embodiments;

FIG. 13 is a block diagram showing an electronic device according to one or more embodiments; and

FIG. 14 is a diagram showing one or more embodiments in which an electronic device of FIG. 13 is implemented as a smart phone.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Further, the phrase “in a plan view” means when an object portion is viewed from above.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

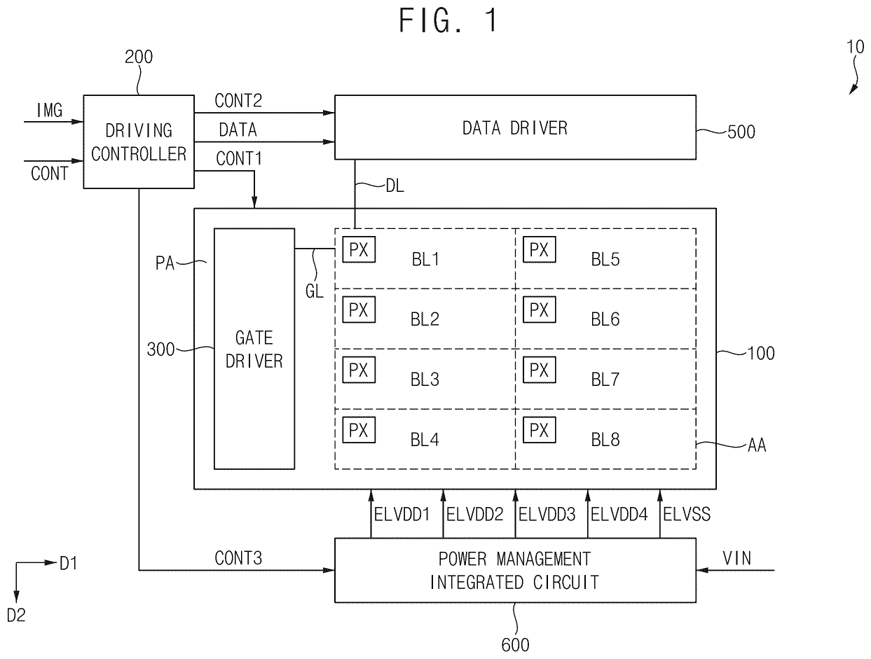

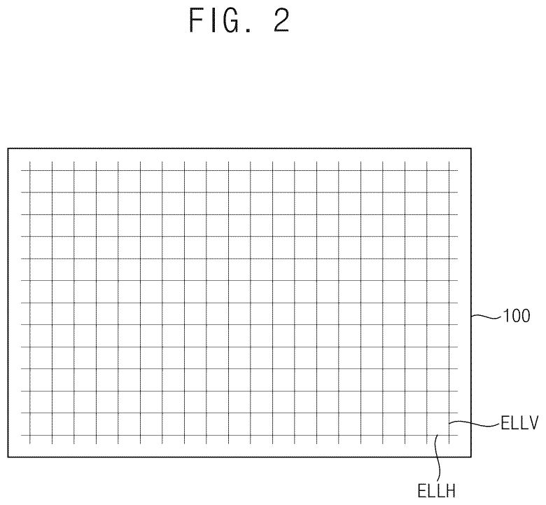

FIG. 1 is a block diagram showing a display device 10 according to embodiments of the present disclosure. FIG. 2 is a diagram showing a power voltage line structure of a display panel 100 of FIG. 1.

Referring to FIG. 1 and FIG. 2, a display device 10 may include a display panel 100 and a display panel driver. The display panel driver may include a driving controller 200, a gate driver 300, and a data driver 500. The display panel driver may further include a power management integrated circuit 600.

For example, the driving controller 200 and the data driver 500 may be formed integrally. A driving module in which at least the driving controller 200 and the data driver 500 are formed integrally may be named a timing controller embedded data driver (TED).

The display panel 100 may include a display area AA for displaying an image and a peripheral area PA located adjacent to the display area AA. In one or more embodiments, the gate driver 300 may be mounted in the peripheral area PA.

For example, in one or more embodiments, the display panel 100 may be an organic light-emitting diode display panel including an organic light-emitting diode. For example, the display panel 100 may be a quantum-dot organic light-emitting diode display panel including an organic light-emitting diode and a quantum-dot color filter. For example, the display panel 100 may be a quantum-dot nano light-emitting diode display panel including a nano light-emitting diode and a quantum-dot color filter.

The display panel 100 may include gate lines GL, data lines DL, and pixels PX electrically connected to the gate lines GL and the data lines DL, respectively. The gate lines GL may extend in a first direction D1, the data lines DL may extend in a second direction D2 crossing the first direction D1.

In one or more embodiments, the driving controller 200 may receive input image data IMG and an input control signal CONT from an external processor. For example, the input image data IMG may include red image data, green image data, and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, and a data signal DATA based on the input image data IMG and the input control signal CONT.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the power management integrated circuit 600 based on the input image data IMG and the input control signal CONT, and may output the third control signal CONT3 to the power management integrated circuit 600.

The gate driver 300 may generate gate signals for driving the gate lines GL in response to the first control signal CONT1 received from the driving controller 200. The gate driver 300 may output the gate signals to the gate lines GL.

The data driver 500 may receive the second control signal CONT2 and the data signal DATA from the driving controller 200. The data driver 500 may convert the data signal DATA into a data voltage having an analog type. The data driver 500 may output the data voltage to the data line DL.

In one or more embodiments, the power management integrated circuit 600 may generate a power voltage ELVDD based on the third control signal CONT3 received from the driving controller 200 and an input voltage VIN received from an external device to output the power voltage to the display panel 100. The power voltage ELVDD may include a plurality of power voltages. For example, the power voltages may include first to fourth power voltages ELVDD1, ELVDD2, ELVDD3, and/or ELVDD4. The first to fourth power voltages ELVDD1, ELVDD2, ELVDD3, and/or ELVDD4 may have different voltages. The power management integrated circuit 600 may generate a low power voltage ELVSS based on the input voltage VIN to output the low power voltage ELVSS to the display panel 100. The power voltage ELVDD may be a high power voltage applied to the pixels PX of the display panel 100, and the low power voltage ELVSS may be a low power voltage applied to the pixels PX of the display panel 100.

The display panel 100 (e.g., the display area AA) may be divided into a plurality of blocks. For example, the blocks may include first to eighth blocks BL1 to BL8. In one or more embodiments, each of the blocks may include a same number of pixels PX. The power management integrated circuit 600 may output each power voltage to each of the blocks.

The display panel 100 may include power lines ELLH to which the power voltage ELVDD is applied, and which extend in the first direction D1, and also may include power lines ELLV to which the power voltage ELVDD is applied, and which extend in the second direction D2. For example, the first direction D1 may be a horizontal direction, and the second direction D2 may be a vertical direction.

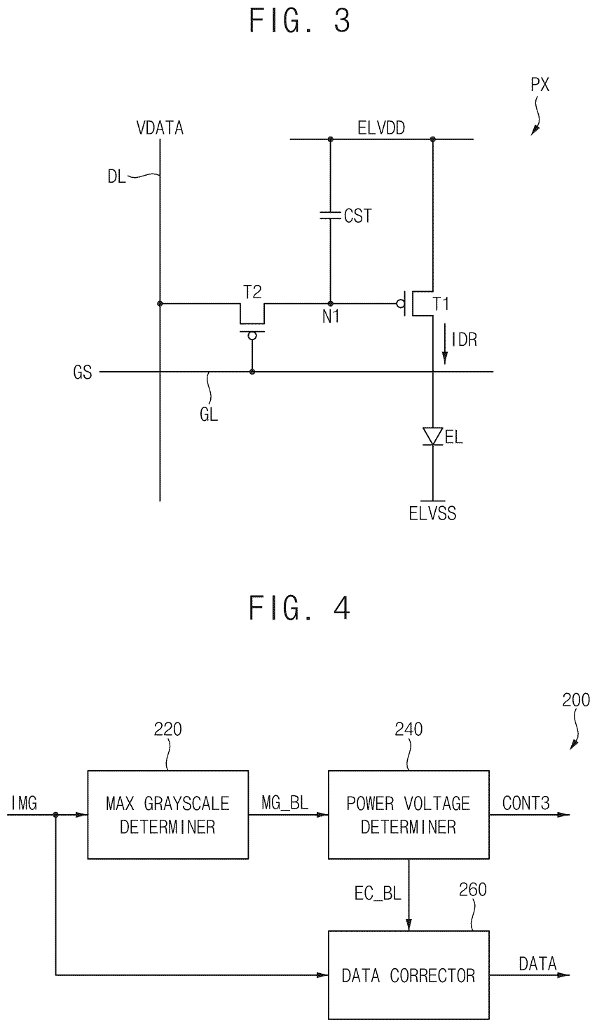

FIG. 3 is a circuit diagram showing a pixel PX of FIG. 1.

Referring to FIGS. 1 to 3, a display panel 100 may include pixels PX. Each of the pixels PX may include a first transistor T1, a second transistor T2, a storage capacitor CST, and a light-emitting element EL. In one or more embodiments, the first transistor T1 and the second transistor T2 may be PMOS transistors.

The first transistor T1 may include a gate electrode connected to a first node N1, a first electrode receiving a power voltage ELVDD, and a second electrode. The first transistor T1 may generate a driving current IDR based on a voltage of the first node N1 and the power voltage ELVDD.

The second transistor T2 may include a gate electrode connected to a gate line GL transmitting a gate signal GS, a first electrode connected to a data line DL transmitting a data voltage VDATA, and a second electrode connected to the first node N1. The second transistor T2 may be turned on in response to a gate signal GS having a low level to provide the data voltage VDATA to the first node N1.

The storage capacitor CST may include a first electrode receiving the power voltage ELVDD and a second electrode connected to the first node N1. The storage capacitor CST may store the data voltage VDATA.

The light-emitting element EL may include an anode connected to the second electrode of the first transistor T1 and a cathode receiving a low power voltage ELVSS. The light-emitting element EL may emit a light based on the driving current IDR.

However, the present disclosure is not limited thereto. In FIG. 3, each of the pixels PX is shown as including two transistors and one capacitor. However, each of the pixels PX may include at least three or more transistors or at least two or more capacitors.

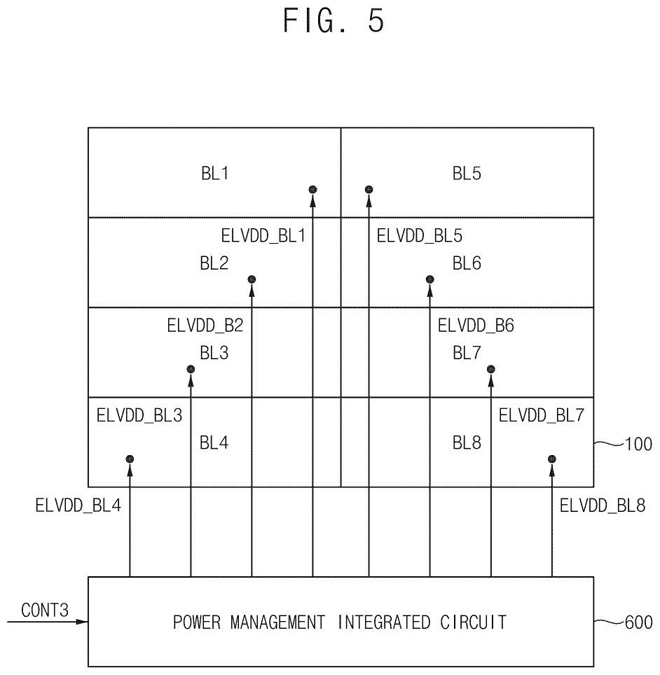

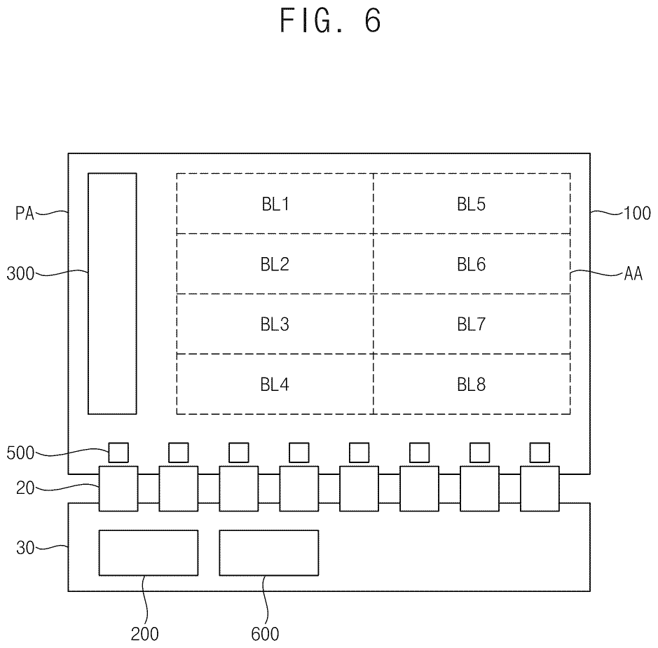

FIG. 4 is a block diagram showing a driving controller 200 of FIG. 1. FIG. 5 is a block diagram showing blocks of a display panel 100 and a power management integrated circuit 600 of FIG. 1.

Referring to FIGS. 1 to 5, a display panel 100 may be divided into a plurality of blocks. For example, the blocks may include first to eighth blocks BL1 to BL8. In one or more embodiments, each of the blocks may include a same number of pixels PX.

The driving controller 200 may include a maximum grayscale determiner 220, a power voltage determiner 240, and a data corrector 260.

The maximum grayscale determiner 220 may determine a maximum grayscale MG_BL of input image data IMG for each block based on the input image data IMG. For example, the maximum grayscale MG_BL of the input image data IMG for each block may be determined for the first to eighth blocks BL1 to BL8.

The power voltage determiner 240 may determine a voltage level EC_BL for each block based on the maximum grayscale MG_BL of the input image data IMG for each block. For example, the voltage level EC_BL for each block may be determined for the first to eighth blocks BL1 to BL8.

The data corrector 260 may perform a gamma correction on the input image data IMG based on the voltage level EC_BL for each block to generate a data signal DATA. When the gamma correction is performed, the blocks may have a same luminance for a same grayscale. For example, even if power voltages are different from each other, when the gamma correction is performed, different blocks may have a same luminance for a same grayscale.

The power voltage determiner 240 may generate a third control signal CONT3 based on the maximum grayscale MG_BL of the input image data IMG for each block, and may output the third control signal CONT3 to the power management integrated circuit 600.

The power management integrated circuit 600 may generate a power voltage for each block based on the third control signal CONT3, and may output the power voltage to the display panel 100. For example, the power management integrated circuit 600 may generate a power voltage ELVDD_BL1 for the first block BL1, and may output the power voltage ELVDD_BL1 for the first block BL1 to the first block BL1. For example, the power management integrated circuit 600 may generate a power voltage ELVDD_BL2 for the second block BL2, and may output the power voltage ELVDD_BL2 for the second block BL2 to the second block BL2. For example, the power management integrated circuit 600 may generate a power voltage ELVDD_BL3 for the third block BL3, and may output the power voltage ELVDD_BL3 for the third block BL3 to the third block BL3. For example, the power management integrated circuit 600 may generate a power voltage ELVDD_BL4 for the fourth block BL4, and may output the power voltage ELVDD_BL4 for the fourth block BL4 to the fourth block BL4. For example, the power management integrated circuit 600 may generate a power voltage ELVDD_BL5 for the fifth block BL5, and may output the power voltage ELVDD_BL5 for the fifth block BL5 to the fifth block BL5. For example, the power management integrated circuit 600 may generate a power voltage ELVDD_BL6 for the sixth block BL6, and may output the power voltage ELVDD_BL6 for the sixth block BL6 to the sixth block BL6. For example, the power management integrated circuit 600 may generate a power voltage ELVDD_BL7 for the seventh block BL7, and may output the power voltage ELVDD_BL7 for the seventh block BL7 to the seventh block BL7. For example, the power management integrated circuit 600 may generate a power voltage ELVDD_BL8 for the eighth block BL8, and may output the power voltage ELVDD_BL8 for the eighth block BL8 to the eighth block BL8.

The power voltage ELVDD_BL1 for the first block BL1, the power voltage ELVDD_BL2 for the second block BL2, the power voltage ELVDD_BL3 for the third block BL3, the power voltage ELVDD_BL4 for the fourth block BL4, the power voltage ELVDD_BL5 for the fifth block BL5, the power voltage ELVDD_BL6 for the sixth block BL6, the power voltage ELVDD_BL7 for the seventh block BL7, and the power voltage ELVDD_BL8 for the eighth block BL8 may be one of first to fourth power voltages ELVDD1, ELVDD2, ELVDD3, and/or ELVDD4.

If the maximum grayscale MG_BL of the input image data IMG for each block is relatively large, each power voltage applied to each block may be relatively large (e.g., as a maximum grayscale of the input image data for one of the blocks increases, a corresponding one of the power voltages for the one of the blocks increases). For example, as the maximum grayscale MG_BL of the input image data IMG for the first block BL1 is large, the power voltage ELVDD_BL1 for the first block BL1 may be large. For example, as the maximum grayscale MG_BL of the input image data IMG for the second block BL2 is large, the power voltage ELVDD_BL1 for the second block BL2 may be large. For example, as the maximum grayscale MG_BL of the input image data IMG for the third block BL3 is large, the power voltage ELVDD_BL3 for the third block BL3 may be large. For example, as the maximum grayscale MG_BL of the input image data IMG for the fourth block BL4 is large, the power voltage ELVDD_BL4 for the fourth block BL4 may be large. For example, as the maximum grayscale MG_BL of the input image data IMG for the fifth block BL5 is large, the power voltage ELVDD_BL5 for the fifth block BL5 may be large. For example, as the maximum grayscale MG_BL of the input image data IMG for the sixth block BL6 is large, the power voltage ELVDD_BL6 for the sixth block BL6 may be large. For example, as the maximum grayscale MG_BL of the input image data IMG for the seventh block BL7 is large, the power voltage ELVDD_BL7 for the seventh block BL7 may be large. For example, as the maximum grayscale MG_BL of the input image data IMG for the eighth block BL8 is large, the power voltage ELVDD_BL8 for the eighth block BL8 may be large.

FIG. 6 is a plan view showing a display device 10 of FIG. 1.

Referring to FIGS. 1 to 6, a display device 10 may include a display panel 100, a flexible film 20, a data driver 500, a main circuit board 30, a driving controller 200, and a power management integrated circuit 600.

The display panel 100 may include a display area AA for displaying an image, and a peripheral area PA arranged adjacent to the display area AA. The display area AA may be divided into, or configured into, a plurality of blocks. For example, the blocks may include first to eighth blocks BL1 to BL8. In one or more embodiments, each of the blocks may include a same number of pixels PX. In one or more embodiments, the gate driver 300 may be mounted in the peripheral area PA. In one or more embodiments, a pad portion connected to the flexible film 20 may be mounted on the peripheral area PA.

The data driver 500 may be mounted on the peripheral area PA. For example, the data driver 500 may be mounted on the peripheral area PA using a COG (Chip-on-Glass) method, a COP (Chip-on-Plastic) method, or an ultrasonic bonding method.

One side of the flexible film 20 may be connected to the main circuit board 30, and the other side of the flexible film 20 may be connected to the pad portion. The flexible film 20 may be a FPCB (Flexible Printed Circuit Board).

The driving controller 200 and the power management integrated circuit 600 may be mounted on the main circuit board 30. The main circuit board 30 may be a PCB (Printed Circuit Board). The power management integrated circuit 600 may include power voltage circuits and low power voltage circuits, and the power voltage circuits may be implemented as one integrated circuit (IC). The power voltage circuits and the low power voltage circuit implemented as one integrated circuit may be packaged together. The power management integrated circuit 600 may be mounted on the main circuit board 30 in a form of a package. The package may be a QFN (Quad Flat No-Lead) package. The QFN package has a flat package form and has a high density structure. The QFN package may be suitable for a PCB with a small space.

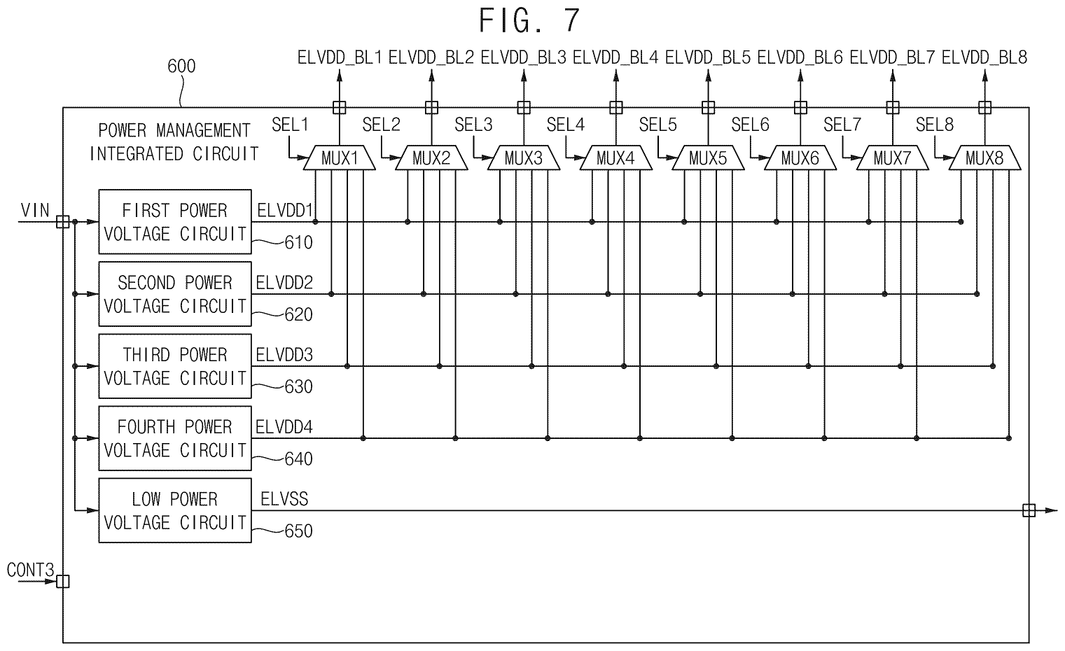

FIG. 7 is a diagram showing a power management integrated circuit 600 having a package form according to one or more embodiments.

Referring to FIGS. 1 to 7, the power management integrated circuit 600 may include power voltage circuits and a low power voltage circuit 650.

The power voltage circuits may generate power voltages based on an input voltage VIN. For example, the power voltage circuits may include first to fourth power voltage circuits 610, 620, 630, and/or 640. For example, the first power voltage circuit 610 may generate and output a first power voltage ELVDD1 based on the input voltage VIN. For example, the second power voltage circuit 620 may generate and output a second power voltage ELVDD2 based on the input voltage VIN. For example, the third power voltage circuit 630 may generate and output a third power voltage ELVDD3 based on the input voltage VIN. For example, the fourth power voltage circuit 640 may generate and output a fourth power voltage ELVDD4 based on the input voltage VIN. For example, the low power voltage circuit 650 may generate and output a low power voltage ELVSS based on the input voltage VIN.

The power management integrated circuit 600 may further include multiplexers, which output one of the power voltages as each power voltage for each block in response to a selection signal. For example, the multiplexers may include first to eighth multiplexers MUX1 to MUX8. For example, the first multiplexer MUX1 may output one of the first to fourth power voltages ELVDD1, ELVDD2, ELVDD3, and/or ELVDD4 as a power voltage ELVDD_BL1 for a first block BL1 in response to the first selection signal SEL1. The power voltage ELVDD_BL1 for the first block BL1 may be applied to the first block BL1. For example, the second multiplexer MUX2 may output one of the first to fourth power voltages ELVDD1, ELVDD2, ELVDD3, and/or ELVDD4 as a power voltage ELVDD_BL2 for a second block BL2 in response to a second selection signal SEL2. The power voltage ELVDD_BL2 for the second block BL2 may be applied to the second block BL2. For example, the third multiplexer MUX3 may output one of the first to fourth power voltages ELVDD1, ELVDD2, ELVDD3, and/or ELVDD4 as a power voltage ELVDD_BL3 for a third block BL3 in response to a third selection signal SEL3. The power voltage ELVDD_BL3 for the third block BL3 may be applied to the third block BL3. For example, the fourth multiplexer MUX4 may output one of the first to fourth power voltages ELVDD1, ELVDD2, ELVDD3, and/or ELVDD4 as a power voltage ELVDD_BL4 for a fourth block BL4 in response to a fourth selection signal SEL4. The power voltage ELVDD_BL4 for the fourth block BL4 may be applied to the fourth block BL4. For example, the fifth multiplexer MUX5 may output one of the first to fourth power voltages ELVDD1, ELVDD2, ELVDD3, and/or ELVDD4 as a power voltage ELVDD_BL5 for a fifth block BL5 in response to a fifth selection signal SEL5. The power voltage ELVDD_BL5 for the fifth block BL5 may be applied to the fifth block BL5. For example, the sixth multiplexer MUX6 may output one of the first to fourth power voltages ELVDD1, ELVDD2, ELVDD3, and/or ELVDD4 as a power voltage ELVDD_BL6 for a sixth block BL6 in response to a sixth selection signal SEL6. The power voltage ELVDD_BL7 for the seventh block BL7 may be applied to the seventh block BL7. For example, the eighth multiplexer MUX8 may output one of the first to fourth power voltages ELVDD1, ELVDD2, ELVDD3, and/or ELVDD4 as a power voltage ELVDD_BL8 for an eighth block BL8 in response to an eighth selection signal SEL8. The power voltage ELVDD_BL8 for the eighth block BL8 may be applied to the eighth block BL8. The first to eighth selection signals SEL1 to SEL8 may be included in a third control signal CONT3 output from a driving controller 200. Because each of the first to eighth multiplexers MUX1 to MUX8 is a 4:1 multiplexer, each of the first to eighth selection signals SEL1 to SEL8 may have 2 bits.

In a conventional case, the power voltage circuits and the low power voltage circuit 650 are each implemented as a package including an integrated circuit, and a size of each package may be about 5 mm×about 4 mm. The multiplexers may also be implemented as a package including an integrated circuit, and a size of each package may be about 4 mm×about 4 mm.

The power management integrated circuit 600 including the power voltage circuits, the low power voltage circuit 650, and the multiplexers may be implemented as one integrated circuit. The power management integrated circuit 600 implemented as one integrated circuit may be packaged as one. Accordingly, a size of the power management integrated circuit 600 may be reduced.

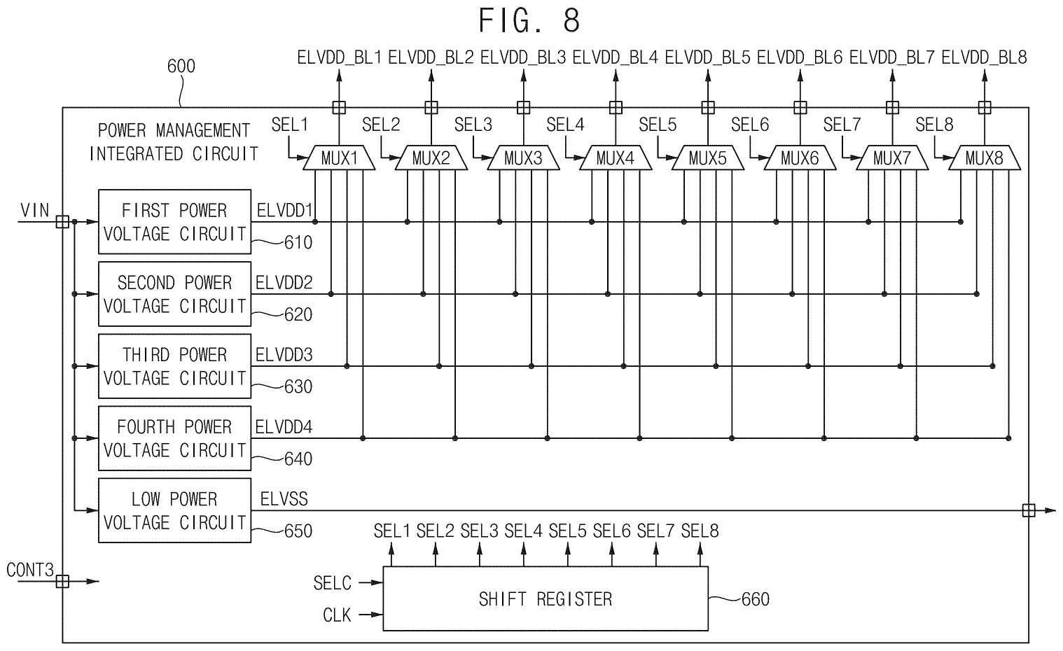

FIG. 8 is a diagram showing a power management integrated circuit 600 having a package form according to one or more embodiments.

Referring to FIGS. 1 to 8, a power management integrated circuit 600 may include power voltage circuits and a low power voltage circuit 650.

The power voltage circuits may generate power voltages based on an input voltage VIN. For example, the power voltage circuits may include first to fourth power voltage circuits 610, 620, 630, and/or 640, which output first to fourth power voltages ELVDD1, ELVDD2, ELVDD3, and/or ELVDD4 based on an input voltage VIN.

The low power voltage circuit 650 may output a low power voltage ELVSS based on the input voltage VIN.

The power management integrated circuit 600 may further include multiplexers, which output one of the power voltages as each power voltage for each block in response to a selection signal. For example, the multiplexers may include first to eighth multiplexers MUX1 to MUX8, and the selection signal may include first to eighth selection signals SEL1 to SEL8. Because each of the first to eighth multiplexers MUX1 to MUX8 is a 4:1 multiplexer, each of the first to eighth selection signals SEL1 to SEL8 may have 2 bits.

When the first to eighth selection signals SEL1 to SEL8 are included in a third control signal CONT3 output from a driving controller 200, a package including the power management integrated circuit 600 may suitably have a plurality of pins. Because the first to eighth selection signals SEL1 to SEL8 are input from an outside of the package including the power management integrated circuit 600, the package may suitably have the plurality of pins. Because each of the first to eighth selection signals SEL1 to SEL8 has 2 bit, the package including the power management integrated circuit 600 may suitably have at least 16 (=8×2) pins.

To reduce or prevent the likelihood of this problem, the power management integrated circuit 600 may further include a shift register 660. The shift register 660 may generate and output the selection signal in response to a selection control signal SELC and a clock signal CLK. For example, the selection signal may include the first to eighth selection signals SEL1 to SEL8. The selection control signal SELC and the clock signal CLK may be included in the third control signal CONT3 output from the driving controller 200. In this case, the package including the power management integrated circuit 600 may suitably have two pins for the selection control signal SELC and the clock signal CLK.

In a conventional case, the power voltage circuits and the low power voltage circuit 650 are each implemented as a package including an integrated circuit, and a size of each package may be about 5 mm×about 4 mm. The multiplexers may also be implemented as a package including an integrated circuit, and a size of each package may be about 4 mm×about 4 mm.

The power management integrated circuit 600 including the power voltage circuits, the low power voltage circuit 650, the multiplexers, and the shift register 660 may be implemented as one integrated circuit. The power management integrated circuit 600 implemented as one integrated circuit may be packaged as one. Accordingly, a size of the power management integrated circuit 600 may be reduced.

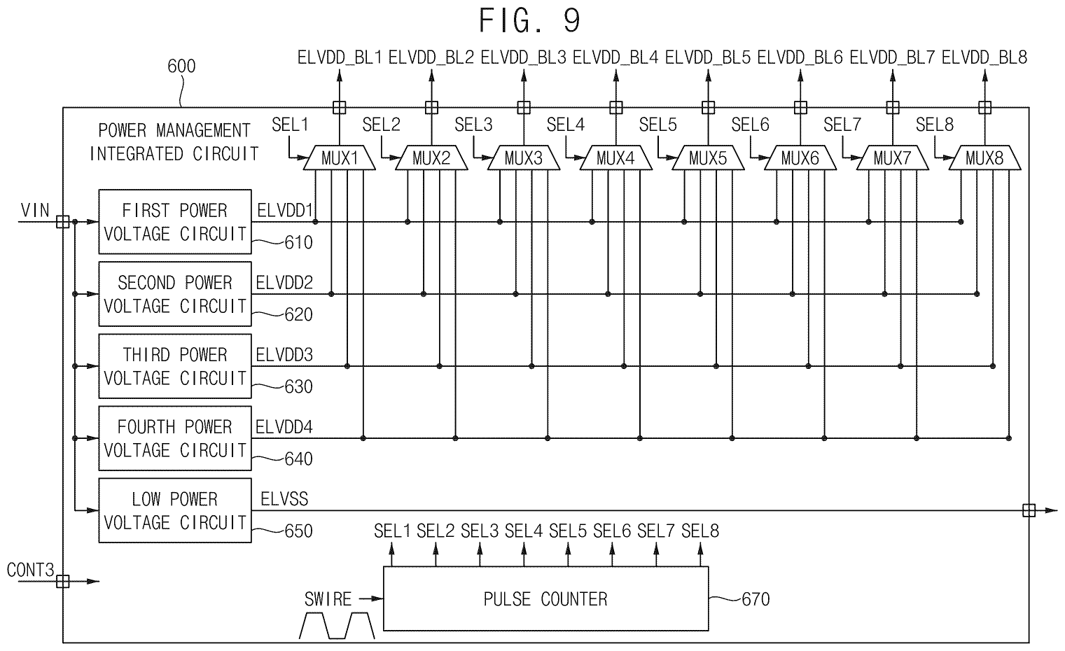

FIG. 9 is a diagram showing a power management integrated circuit 600 having a package form according to one or more embodiments.

Referring to FIGS. 1 to 9, a power management integrated circuit 600 may include power voltage circuits and a low power voltage circuit 650.

The power voltage circuits may generate power voltages based on an input voltage VIN. For example, the power voltage circuits may include first to fourth power voltage circuits 610, 620, 630, and/or 640, which output first to fourth power voltages ELVDD1, ELVDD2, ELVDD3, and/or ELVDD4 based on the input voltage VIN.

The low power voltage circuit 650 may output a low power voltage ELVSS based on the input voltage VIN.

The power management integrated circuit 600 may further include multiplexers, which output one of the power voltages as each power voltage for each block in response to a selection signal. For example, the multiplexers may include first to eighth multiplexers MUX1 to MUX8, and the selection signal may include first to eighth selection signals SEL1 to SEL8. Because each of the first to eighth multiplexers MUX1 to MUX8 is a 4:1 multiplexer, each of the first to eighth selection signals SEL1 to SEL8 may have 2 bits.

When the first to eighth selection signals SEL1 to SEL8 are included in a third control signal CONT3 output from a driving controller 200, a package including the power management integrated circuit 600 may suitably have a plurality of pins. Because the first to eighth selection signals SEL1 to SEL8 are input from an outside of the package including the power management integrated circuit 600, the package may suitably have a plurality of pins. Because each of the first to eighth selection signals SEL1 to SEL8 has 2 bit, the package including the power management integrated circuit 600 may suitably have at least 16 (=8×2) pins.

To reduce or prevent the likelihood of this problem, the power management integrated circuit 600 may further include a pulse counter 670. The pulse counter 670 may generate and output the selection signal in response to a swire signal SWIRE. The pulse counter 670 may count pulses of the swire signal SWIRE to generate the selection signal. For example, the selection signal may include the first to eighth selection signals SEL1 to SEL8. The swire signal SWIRE may be included in the third control signal CONT3 output from the driving controller 200. In this case, the package including the power management integrated circuit 600 may suitably have one pin for the SWIRE signal.

In a conventional case, the power voltage circuits and the low power voltage circuit 650 are each implemented as a package including an integrated circuit, and a size of each package may be about 5 mm×about 4 mm. The multiplexers may also be implemented as a package including an integrated circuit, and a size of each package may be about 4 mm×about 4 mm.

The power management integrated circuit 600 including the power voltage circuits, the low power voltage circuit 650, the multiplexers, and the pulse counter 670 may be implemented as one integrated circuit. The power management integrated circuit 600 implemented as one integrated circuit may be packaged as one. Accordingly, a size of the power management integrated circuit 600 may be reduced.

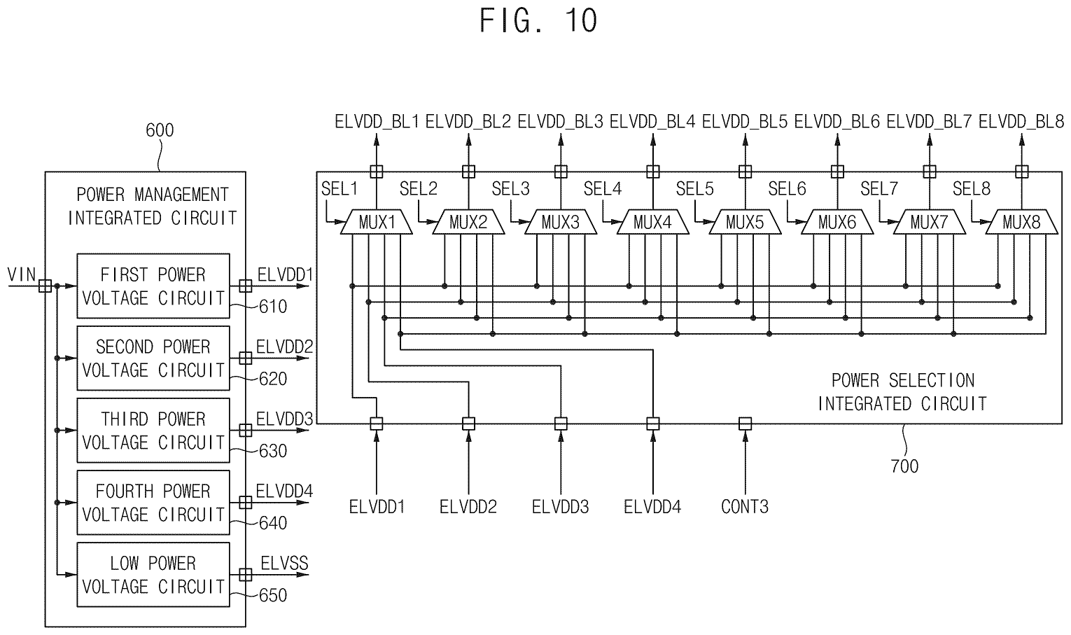

FIG. 10 is a diagram showing a power management integrated circuit 600 having a package form and a power selection integrated circuit 700 having a package form according to one or more embodiments.

Referring to FIGS. 1 to 10, a power management integrated circuit 600 may include power voltage circuits and a low power voltage circuit 650.

The power voltage circuits may generate power voltages based on an input voltage VIN. For example, the power voltage circuits may include first to fourth power voltage circuits 610, 620, 630, and/or 640, which output first to fourth power voltages ELVDD1, ELVDD2, ELVDD3, and/or ELVDD4 based on the input voltage VIN.

The low power voltage circuit 650 may output a low power voltage ELVSS based on the input voltage VIN.

The power management integrated circuit 600 including the power voltage circuits and the low power voltage circuit 650 may be implemented as one integrated circuit. The power management integrated circuit 600 implemented as one integrated circuit may be packaged as one. Accordingly, a size of the power management integrated circuit 600 may be reduced.

The display device 10 of FIG. 1 may further include a power selection integrated circuit 700.

The power selection integrated circuit 700 may further include multiplexers, which output one of the power voltages as each power voltage for each block in response to a selection signal. For example, the multiplexers may include first to eighth multiplexers MUX1 to MUX8, and the selection signal may include first to eighth selection signals SEL1 to SEL8. The first to eighth selection signals SEL1 to SEL8 may be included in a third control signal CONT3 output from a driving controller 200, and the third control signal CONT3 may be applied to the power selection integrated circuit 700 rather than the power management integrated circuit 600. Because each of the first to eighth multiplexers MUX1 to MUX8 is a 4:1 multiplexer, each of the first to eighth selection signals SEL1 to SEL8 may have 2 bits.

The power selection integrated circuit 700 including the multiplexers may be implemented as one integrated circuit. The power selection integrated circuit 700 implemented as one integrated circuit may be packaged as one. Accordingly, a size of the power selection integrated circuit 700 may be reduced.

When the power management integrated circuit 600 and the power selection integrated circuit 700 are packaged as one, the size of the one package may be excessively large. To reduce or prevent the likelihood of this problem, the power management integrated circuit 600 and the power selection integrated circuit 700 may be packaged separately.

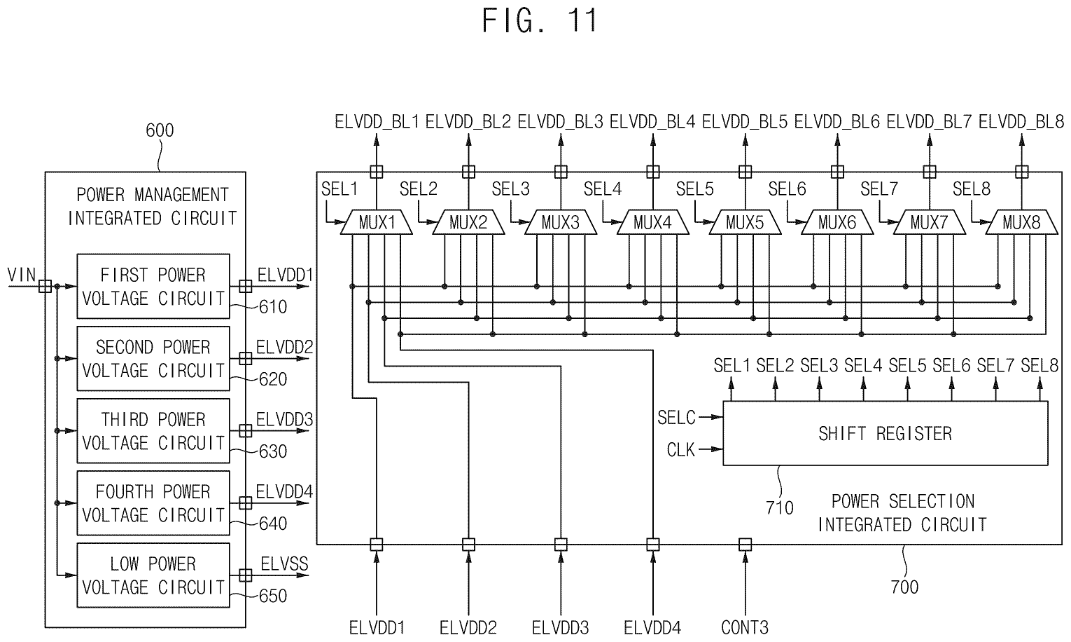

FIG. 11 is a diagram showing a power management integrated circuit 600 having a package form and a power selection integrated circuit 700 having a package form according to one or more embodiments.

Referring to FIGS. 1 to 11, a power management integrated circuit 600 may include power voltage circuits and a low power voltage circuit 650.

The power voltage circuits may generate power voltages based on an input voltage VIN. For example, the power voltage circuits may include first to fourth power voltage circuits 610, 620, 630, and/or 640, which output first to fourth power voltages ELVDD1, ELVDD2, ELVDD3, and/or ELVDD4 based on the input voltage VIN.

The low power voltage circuit 650 may output a low power voltage ELVSS based on the input voltage VIN.

The power management integrated circuit 600 including the power voltage circuits and the low power voltage circuit 650 may be implemented as one integrated circuit. The power management integrated circuit 600 implemented as one integrated circuit may be packaged as one. Accordingly, a size of the power management integrated circuit 600 may be reduced.

The display device 10 of FIG. 1 may further include a power selection integrated circuit 700.

The power selection integrated circuit 700 may further include multiplexers, which output one of the power voltages as each power voltage for each block in response to a selection signal. For example, the multiplexers may include first to eighth multiplexers MUX1 to MUX8, and the selection signal may include first to eighth selection signals SEL1 to SEL8. The first to eighth selection signals SEL1 to SEL8 may be included in a third control signal CONT3 output from a driving controller 200, and the third control signal CONT3 may be applied to the power selection integrated circuit 700 rather than the power management integrated circuit 600. Because each of the first to eighth multiplexers MUX1 to MUX8 is a 4:1 multiplexer, each of the first to eighth selection signals SEL1 to SEL8 may have 2 bits.

When the first to eighth selection signals SEL1 to SEL8 are included in a third control signal CONT3 output from a driving controller 200, a package including the power selection integrated circuit 700 may suitably have a plurality of pins. The first to eighth selection signals SEL1 to SEL8 are input from an outside of the package including the power selection integrated circuit 700, and the package may suitably have a plurality of pins. Because each of the first to eighth selection signals SEL1 to SEL8 has 2 bit, the package including the power selection integrated circuit 700 may suitably have at least 16 (=8×2) pins.

To reduce or prevent the likelihood of this problem, the power selection integrated circuit 700 may further include a shift register 710. The shift register 710 may generate and output the selection signal in response to a selection control signal SELC and a clock signal CLK. For example, the selection signal may include the first to eighth selection signals SEL1 to SEL8. The selection control signal SELC and the clock signal CLK may be included in the third control signal CONT3 output from the driving controller 200. In this case, the package including the power selection integrated circuit 700 may suitably have two pins for the selection control signal SELC and the clock signal CLK.

The power selection integrated circuit 700 including the multiplexers may be implemented as one integrated circuit. The power selection integrated circuit 700 implemented as one integrated circuit may be packaged as one. Accordingly, a size of the power selection integrated circuit 700 may be reduced.

When the power management integrated circuit 600 and the power selection integrated circuit 700 are packaged as one, the size of the one package may be excessively large. To reduce or prevent the likelihood of this problem, the power management integrated circuit 600 and the power selection integrated circuit 700 may be packaged separately.

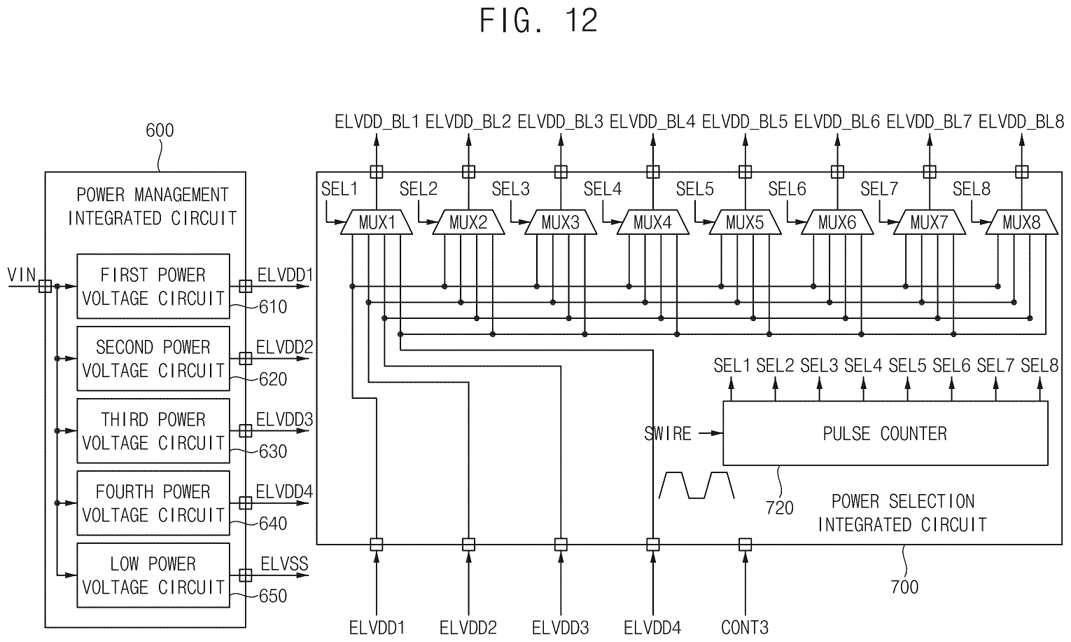

FIG. 12 is a diagram showing a power management integrated circuit 600 having a package form and a power selection integrated circuit 700 having a package form according to one or more embodiments.

Referring to FIGS. 1 to 12, a power management integrated circuit 600 may include power voltage circuits and a low power voltage circuit 650.

The power voltage circuits may generate power voltages based on an input voltage VIN. For example, the power voltage circuits may include first to fourth power voltage circuits 610, 620, 630, and/or 640, which output first to fourth power voltages ELVDD1, ELVDD2, ELVDD3, and/or ELVDD4 based on the input voltage VIN.

The low power voltage circuit 650 may output a low power voltage ELVSS based on the input voltage VIN.

The power management integrated circuit 600 including the power voltage circuits and the low power voltage circuit 650 may be implemented as one integrated circuit. The power management integrated circuit 600 implemented as one integrated circuit may be packaged as one. Accordingly, a size of the power management integrated circuit 600 may be reduced.

The display device 10 of FIG. 1 may further include a power selection integrated circuit 700.

The power selection integrated circuit 700 may further include multiplexers, which output one of the power voltages as each power voltage for each block in response to a selection signal. For example, the multiplexers may include first to eighth multiplexers MUX1 to MUX8, and the selection signal may include first to eighth selection signals SEL1 to SEL8. The first to eighth selection signals SEL1 to SEL8 may be included in a third control signal CONT3 output from a driving controller 200, and the third control signal CONT3 may be applied to the power selection integrated circuit 700 rather than the power management integrated circuit 600. Because each of the first to eighth multiplexers MUX1 to MUX8 is a 4:1 multiplexer, each of the first to eighth selection signals SEL1 to SEL8 may have 2 bits.

When the first to eighth selection signals SEL1 to SEL8 are included in a third control signal CONT3 output from a driving controller 200, a package including the power selection integrated circuit 700 may suitably have a plurality of pins. Because the first to eighth selection signals SEL1 to SEL8 are input from an outside of the package including the power selection integrated circuit 700, the package may suitably have a plurality of pins. Because each of the first to eighth selection signals SEL1 to SEL8 has 2 bit, the package including the power selection integrated circuit 700 may suitably have at least 16 (=8×2) pins.

To reduce or prevent the likelihood of this problem, the power selection integrated circuit 700 may further include a pulse counter 720. The pulse counter 670 may count pulses of the swire signal SWIRE to generate the selection signal. For example, the selection signal may include the first to eighth selection signals SEL1 to SEL8. The swire signal SWIRE may be included in the third control signal CONT3 output from the driving controller 200. In this case, the package including the power selection integrated circuit 700 may suitably have one pin for the swire signal SWIRE.

The power selection integrated circuit 700 including the multiplexers may be implemented as one integrated circuit. The power selection integrated circuit 700 implemented as one integrated circuit may be packaged as one. Accordingly, a size of the power selection integrated circuit 700 may be reduced.

When the power management integrated circuit 600 and the power selection integrated circuit 700 are packaged as one, the size of the one package may be excessively large. To reduce or prevent the likelihood of this problem, the power management integrated circuit 600 and the power selection integrated circuit 700 may be packaged separately.

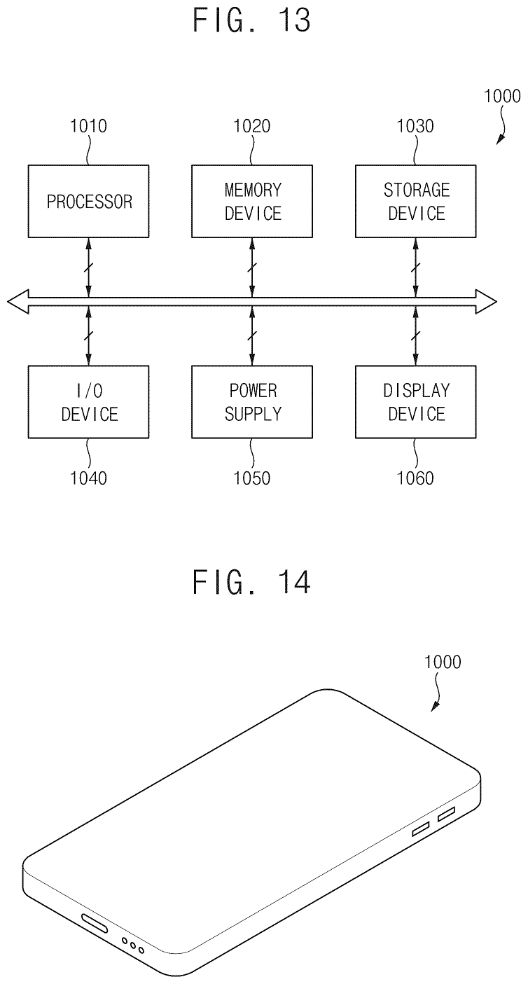

FIG. 13 is a block diagram showing an electronic device 1000. FIG. 14 is a diagram showing one or more embodiments in which an electronic device 1000 of FIG. 13 is implemented as a smart phone.

Referring to FIGS. 13 and 14, the electronic device 1000 may include a processor 1010, a memory device 1020, a storage device 1030, an input/output I/O device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus USB device, other electronic device, and the like.

In one or more embodiments, as shown in FIG. 14, the electronic device 1000 may be implemented as the smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head-mounted display HMD device, and the like.

The processor 1010 may perform various computing functions. The processor 1010 may be a microprocessor, a central processing unit CPU, an application processor AP, and the like. The processor 1010 may be coupled to other components via an address bus, a control bus, a data bus, and the like. Further, the processor 1010 may be coupled to an extended bus, such as a peripheral component interconnection PCI bus.

The memory device 1020 may store data for operations of the electronic device 1000. For example, the memory device 1020 may include at least one nonvolatile memory device, such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and the like and/or at least one volatile memory device, such as a dynamic random access memory DRAM device, a static random access memory SRAM device, a mobile DRAM device, and the like.

The storage device 1030 may include a solid state drive SSD device, a hard disk drive HDD device, a CD-ROM device, and the like.

The I/O device 1040 may include an input device, such as a keyboard, a keypad, a mouse device, a touch-pad, a touch-screen, and the like, and an output device, such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

The disclosed embodiments may be applied to any display device and any electronic device including the touch panel. For example, the disclosed embodiments may be applied to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, etc.

The foregoing is illustrative, and is not to be construed as limiting thereof. Although embodiments have been described, those skilled in the art will readily appreciate that many modifications are possible in the embodiments without materially departing from the aspects of the present disclosure. Accordingly, all such modifications are intended to be included within the scope of the present disclosure as defined in the claims, with functional equivalents thereof to be included therein. In the claims, means-plus-function clauses are intended to cover the structures described herein as performing the recited function and not only structural equivalents but also equivalent structures. Therefore, it is to be understood that the foregoing is illustrative, and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A display device, comprising
a display panel comprising pixels, and configured into blocks;
a data driver configured to provide a data voltage to the display panel;
a power management integrated circuit comprising power voltage circuits implemented as one integrated circuit, packaged together, and configured to output power voltages respectively to the blocks of the display panel; and
a driving controller configured to control the data driver and the power management integrated circuit based on input image data.

2. The display device of claim 1, wherein, as a maximum grayscale of the input image data for one of the blocks increases, a corresponding one of the power voltages for the one of the blocks increases.

3. The display device of claim 1, wherein the power management integrated circuit further comprises multiplexers configured to respectively output the power voltages in response to a selection signal.

4. The display device of claim 3, wherein the power management integrated circuit comprising the power voltage circuits and the multiplexers is packaged as one integrated circuit.

5. The display device of claim 3, wherein the driving controller is configured to output the selection signal.

6. The display device of claim 3, wherein the power management integrated circuit further comprises a shift register configured to generate the selection signal in response to a control signal from the driving controller.

7. The display device of claim 3, wherein the power management integrated circuit further comprises a pulse counter configured to generate the selection signal in response to a control signal from the driving controller.

8. The display device of claim 1, wherein the display device further comprises a power selection integrated circuit comprising multiplexers configured to respectively output the power voltages to the blocks in response to a selection signal.

9. The display device of claim 8, wherein the power management integrated circuit comprising the power voltage circuits is implemented as one integrated circuit packaged as one, and
wherein the power selection integrated circuit comprising the multiplexers is implemented as one integrated circuit packaged as one.

10. The display device of claim 8, wherein the driving controller is configured to output the selection signal.

11. The display device of claim 8, wherein the power selection integrated circuit further comprises a shift register configured to generate the selection signal in response to a control signal from the driving controller.

12. The display device of claim 8, wherein the power selection integrated circuit further comprises a pulse counter configured to generate the selection signal in response to a control signal from the driving controller.

13. An electronic device, comprising
a display panel comprising pixels, and configured into blocks;
a data driver configured to provide a data voltage to the display panel;
a power management integrated circuit comprising power voltage circuits packaged together, implemented as one integrated circuit, and configured to output power voltages respectively to the blocks of the display panel;
a driving controller configured to control the data driver and the power management integrated circuit based on input image data; and
a processor configured to provide the input image data and an input control signal to the driving controller.

14. The electronic device of claim 13, wherein, as a maximum grayscale of the input image data for one of the blocks increases, a corresponding one of the power voltages applied to the one of the blocks increases.

15. The electronic device of claim 13, wherein the power management integrated circuit further comprises multiplexers configured to output the power voltages respectively to the blocks in response to a selection signal.

16. The electronic device of claim 15, wherein the power management integrated circuit comprising the power voltage circuits and the multiplexers is implemented as one integrated circuit and is packaged as one.

17. The electronic device of claim 15, wherein the driving controller is configured to output the selection signal.

18. The electronic device of claim 15, wherein the power management integrated circuit further comprises a shift register configured to generate the selection signal in response to a control signal from the driving controller.

19. The electronic device of claim 15, wherein the power management integrated circuit further comprises a pulse counter configured to generate the selection signal in response to a control signal from the driving controller.

20. The electronic device of claim 13, further comprising a power selection integrated circuit comprising multiplexers configured to output the power voltages respectively to the blocks in response to a selection signal.
